(19) United States
(12) Patent Application Publication
(10) Pub. No.: US 2009/0065308 A1
(43) Pub. Date: Mar. 12, 2009

(54) Variable-section fork for fork-lift trucks

(76) Inventor: Emilio Bolzoni, Piacenza PC (IT)

Correspondence Address: JACOBSON HOLMAN PLLC, 400 SEVENTH STREET N.W., SUITE 600, WASHINGTON, DC, 20004, US

(21) Appl. No.: 12/230,180

(22) Filed: Aug. 25, 2008

(30) Foreign Application Priority Data
Sep. 7, 2007 (IT) MI2007A 001738

(51) Int. Cl. B66F 9/12; B21D 37/16

(52) U.S. Cl. 187/237; 72/342.94; 414/785

(57) ABSTRACT

An L-shaped fork for fork-lift trucks comprises a first substantially straight section intended to be secured to the truck, a second substantially straight section intended to support a load to be lifted and a knee portion connecting the first section to the second section. The knee portion has a larger cross section than the first and the second section of the fork.

### BACKGROUND OF THE INVENTION

1. Field of the Invention

The present invention refers to an innovative variable-section fork for fork-lift trucks.

2. State of the Prior Art

The manufacture is known of substantially L-shaped steel forks to be used for fork-lift trucks for lifting loads. The fork comprises a first straight section bearing the fasteners for securing to the truck and a second section, horizontal during use, intended to support the load to be lifted. The two sections are connected by a knee portion bent at 90°.

The known forks are obtained by bending a steel bar and have a cross section substantially constant in the straight section and the knee, apart from the tapering normally featured on the free extremity of the horizontal section of the fork.

To obtain satisfactory load resistance and good reliability, the forks made according to the known method require the use of a considerable amount of material and are particularly expensive.

Furthermore, the forks are of considerable weight which goes to burden the fork-lift truck, thereby reducing its load capacity.

The general object of the present invention is to eliminate the aforementioned drawbacks and provide a fork for fork-lift trucks that is inexpensive to make, is of limited weight and, at the same time, maintains satisfactory properties of mechanical strength and reliability.

### SUMMARY OF THE INVENTION

In view of such object, the decision was made to manufacture, according to the invention, an L-shaped fork for fork-lift trucks, the fork comprising a first substantially straight section intended to be secured to the truck, a second substantially straight section intended to support a load to be lifted and a knee portion connecting the first section to the second section, characterized in that the knee portion has a cross section larger than the first and the second section of the fork.

### BRIEF DESCRIPTION OF THE DRAWINGS

To make clearer the explanation of the innovative principles of the present invention and their advantages with respect to the known state of the art, below is a description, with the aid of the attached drawings, of a possible exemplary embodiment in which such principles are applied. In the drawings:

FIG. 1 represents a perspective view of a fork according to the invention with the fasteners for securing to the truck removed;

FIG. 2 represents a view of the fork in FIG. 1, also showing the securing fasteners;

FIG. 3 represents a side view of a part of the fork;

FIG. 4 shows a side view of the knee portion in an alternative installation of the fork according to the present invention.

### DETAILED DESCRIPTION OF THE INVENTION

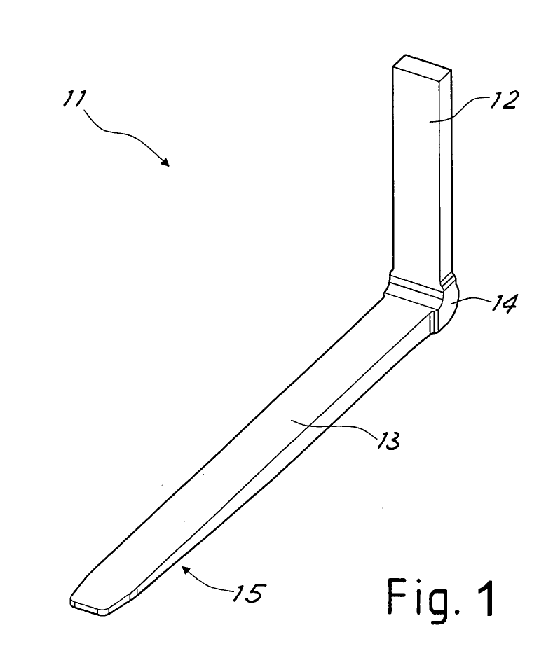

With reference to the illustrations, FIG. 1 shows a fork for fork-lift trucks 11, with a substantially L shape and made of steel.

The fork comprises a first section 12 intended to be secured to the truck (not shown), a second section 13 for supporting the loads to be lifted, and a knee portion 14 connecting the first section to the second section.

The sections 12, 13 are substantially straight and have a rectangular cross section, for example 100 mm wide and 45 mm thick.

During use, the first section 12 is arranged substantially vertically, while the section 13 is horizontal.

The second section 13 has a portion of tapered extremity 15, according to solutions known to the state of the art. The knee portion 14 has a larger cross section compared to the first and the second sections, with section area advantageously increased by at least 10%.

In particular, the knee portion 14 is wider than the sections 12 and 13 by at least 5%, advantageously between 10% and 25%.

In a preferred embodiment, the knee 14 has a section wider by about 15%-20% compared to the straight sections 12 and 13.

For example, with a fork 100 mm wide in the sections 12 and 13, the knee 14 could be made 115-120 mm wide.

The cross section of the straight sections 12, 13 is substantially regular, except for the tapered part 15.

The portion 14 with the increased cross section only realizes the 90° bend, without in fact having any straight portions.

Thanks to the fact of having increased the cross section of the knee with respect to the straight sections, a fork can be made in a less expensive way, saving up to 8-10% of material compared to traditional forks at the straight sections.

The fork will also weigh less, which means a lighter load will bear on the fork-lift truck and consequently its load capacity will be greater.

These advantages are obtained while maintaining satisfactory the mechanical strength characteristics of the fork, because the stress on the straight sections is less than that at the bent knee portion, and consequently a lower steel cross section will suffice in such sections without in fact altering the maximum load the fork can withstand.

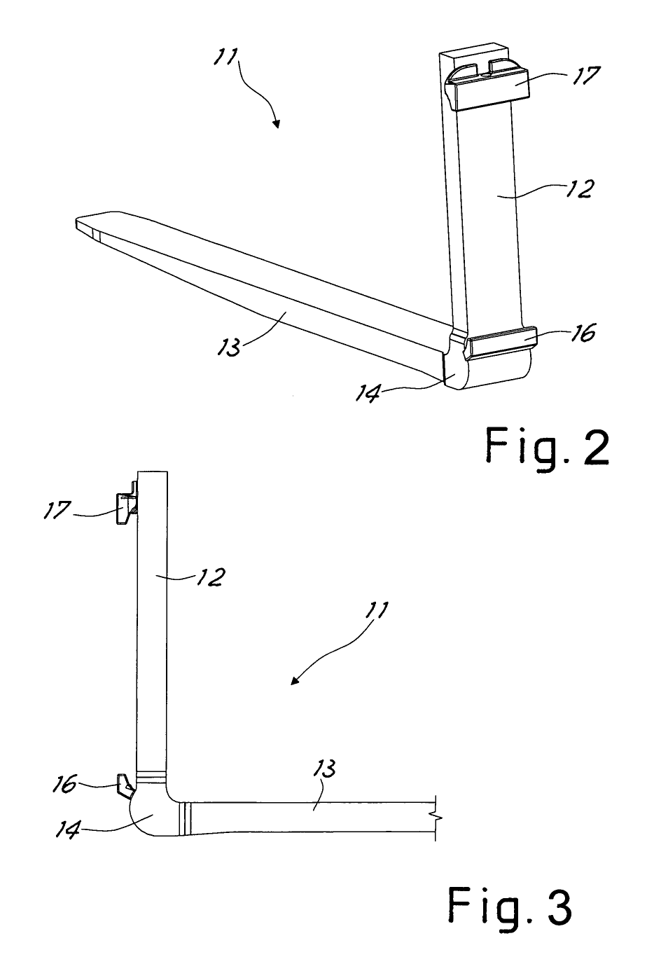

The fork has a pair of fasteners 16, 17 (see FIGS. 2 and 3) for securing to the truck. Advantageously, the upper fastener 17 is welded close to the upper extremity of the section 12 of the fork, while the lower fastener 16 is welded to the fork at the knee portion with cross section increased close to the section 12. Increasing the section of the fork at the lower fastener 16 was found to be particularly advantageous. It was also found that the stress per unit of surface can even be reduced by 15% at the point where such stress is most critical.

As is clearly shown in FIG. 3, the knee 14 can have a slightly greater thickness compared to the sections 12 and 13, as well as a greater width.

The fork according to the invention is advantageously obtained by means of a hot forming process of the knee portion, using a closed-die press to form the knee starting with a straight steel bar with suitable preheating of the portion to be bent.

After forming, the fork undergoes heat treatment and, afterwards, the fasteners are welded.

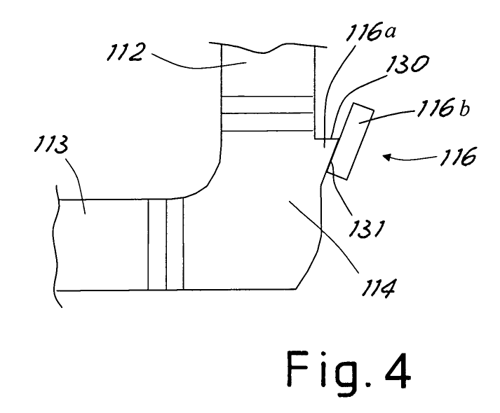

FIG. 4 shows the knee portion in an alternative embodiment of a fork according to the invention. It must be realized that the parts of the fork that are not represented can be made in the same way as the previous embodiment.

The knee portion 114 connects the vertical section 112 of the fork to the horizontal section 113. At the rear part of the knee, a protrusion piece 116a is made forming part of the lower fastener 116 of the fork. Advantageously, the protrusion 116a has a surface 130 which during use remains substantially horizontal and a sloping surface 131 angles at about 60° with respect to the horizontal surface. To the sloping surface 131 is welded a plate 116b that completes the lower fastener 116 of the fork.

The protrusion 116a is formed on the knee portion directly in the closed-die press, while the plate 116b is subsequently welded, following the heat treatment.

This solution permits increasing even more the section of the fork in the critical area and moves the welding of the more stressed area further way, thereby making it possible to further upgrade the mechanical strength of the fork.

At this point, it is obvious how the objects of the present invention have been achieved. A fork has in fact been supplied that is inexpensive to make, lightweight and such as to ensure satisfactory mechanical strength and reliability. With a traditional fork 100 mm wide, 45 mm thick and 1200 mm long, up to 9 kg of material can be saved adding 1 kg in the knee area, cutting costs by about 8-10% compared to the total cost of a fork shaped in the traditional way.

Furthermore, the working load capacity of the truck is increased by 16 kg due to the lower weight of the fork. Naturally, the above description of an embodiment applying the innovative principles of the present invention is shown by way of example of such innovative principles and should not therefore be deemed a limitation within the ambit of the patent right claimed here.

1. L-shaped fork for fork-lift truck, the fork comprising a first substantially straight section intended to be secured to the truck, a second substantially straight section intended to support a load to be lifted and a knee portion connecting the first section to the second section, characterized in that the knee portion has a larger cross section than the first and the second section of the fork.

2. Fork as in claim 1, characterized in that the knee portion has a larger section than said first and second sections by at least 10%.

3. Fork as in claim 1, characterized in that it is wider at the knee portion than the first and second sections.

4. Fork as in claim 3, characterized in that the knee portion is at least 5% wider than the first and second sections.

5. Fork as in claim 3, characterized in that the knee portion is between 10% and 25% wider than the first and second sections.

6. Fork as in claim 1, characterized in that it has two fasteners for securing it to the truck, a first upper fastener being fixed at the first section of the fork, a second lower fastener being fixed near the connection between the first section and the larger-section knee portion.

7. Fork as in claim 1, characterized in that the first and the second sections have a substantially regular section close to the knee portion.

8. Fork as in claim 1, characterized in that it has a substantially rectangular cross section in said first and second section and in the knee portion.

9. Fork as in claim 1, characterized in that the second section has a tapered part at its free extremity.

10. Fork as in claim 1, characterized in that the knee shape is obtained by hot pressing such portion of the fork by means of a closed-die press.

11. Fork as in claim 1, characterized in that the first section, the second section and the knee portion are made in just one piece.

12. Fork as in claim 1, characterized in that at the rear part of the knee portion a protruding piece is formed that forms part of a lower fastener of the fork.

13. Fork as in claim 12, characterized in that said protrusion has a surface, during use, that is sloped with respect to the vertical to which is welded a plate to complete the lower fastener of the fork.

14. Method for the fabrication of a fork according to claim 1, in which the knee portion is formed by means of a closed-die press starting with a straight bar suitably preheated at the portion to be bent.

15. Method according to claim 14, in which the knee portion is formed in the closed-die press with a protrusion piece intended to form part of the lower fastener of the fork, to said protrusion being subsequently welded a further element to complete the lower fastener of the fork.

16. Method as in claim 15, in which the protrusion is formed with a surface that is sloped with respect to the vertical to which a plate is then welded to complete the lower fastener of the fork.
